(19) United States
(12) Patent Application Publication
(10) Pub. No.: US 2015/0084348 A1
(43) Pub. Date: Mar. 26, 2015

(54) DOOR LOCKING INSTALLATION AND LOCKING MECHANISM

(71) Applicant: FIRE & SECURITY HARDWARE PTY LTD., Matraville, NSW (AU)

(72) Inventors: Trevor Mackle, Hornsby (AU); Ernest Armari, Hornsby (AU)

(73) Assignee: FIRE & SECURITY HARDWARE PTY LTD, Matraville, NSW (AU)

(21) Appl. No.: 14/398,966

(22) PCT Filed: Mar. 4, 2013
(86) PCT No.: PCT/AU2013/000198

§ 371 Date: Nov. 4, 2014

(30) Foreign Application Priority Data
May 4, 2012 (AU) 2012901824

(51) Int. Cl. E05B 47/00

(52) U.S. Cl. CPC E05B 47/0012
USPC 292/144

(57) ABSTRACT

A door locking installation is described comprising: a locking mechanism mounted below floor level in association with a door and including a locking element which is moveable between a retracted position and an extended position; an electrically powered actuator which is arranged to drive the locking mechanism by way of a mechanical linkage; the mechanical linkage separates the actuator from the locking mechanism; and wherein the actuator is mounted above floor level.

### TECHNICAL FIELD

The present invention relates to door locking installations and locking mechanisms and particularly to locking installations and mechanisms systems suitable for use in locking a pair of bi-directional swing doors at the lower edge of the doors.

### BACKGROUND TO THE INVENTION

In some door arrangements, such as in the case of bi-directional swing doors, it is not possible to fit mechanical stops to align the door in position for locking the door.

Therefore, it is usually only possible to lock the doors from a position at the top of the door frame. However, this situation is undesirable as persons pushing at the lower region of the door can cause a significant amount of deflection to the door, resulting in either damage to the door, or failure of the top mounted locking arrangement resulting in unauthorised access through the door.

### SUMMARY OF THE INVENTION

In a first aspect the present invention provides a door locking installation comprising: a locking mechanism mounted below floor level in association with a door and including a locking element which is moveable between a retracted position and an extended position; an electrically powered actuator which is arranged to drive the locking mechanism by way of a mechanical linkage; the mechanical linkage separates the actuator from the locking mechanism; and wherein the actuator is mounted above floor level.

The mechanical linkage may include a flexible drive cable mounted in a flexible sheath.

The flexible drive cable may be arranged to rotate within the flexible sheath.

The door locking installation may further include a power storage device to provide power to the actuator in the event that mains power is lost.

The door locking installation may be arranged to move the lock to an unlocked condition in the event that mains power is lost.

In a second aspect the present invention provides a locking mechanism which is arranged for mounting below floor level in association with a door including: a housing; a locking element is mounted in the housing and is associated with a threaded element; rotation of the threaded element causes movement of the locking element between a retracted position and an extended position.

The locking element may include two projecting fingers.

When in the extended position, the locking element may be arranged to rotate between a first position and a second position.

The housing may include guide means which controls rotational movement of the locking element.

The guide means may include grooves provided on the inside surface of the housing.

### BRIEF DESCRIPTION OF THE DRAWINGS

An embodiment of the present invention will now be described, by way of example only, with reference to the accompanying drawings, in which:

FIG. 1 is a schematic view showing an embodiment of a door locking arrangement according to one aspect of the invention including a locking mechanism according to another aspect of the invention which is shown in exploded view;

FIG. 2 is a perspective view of the housing of the locking mechanism of FIG. 1;

FIG. 3 is an enlarged exploded view of selected components of the locking mechanism of FIG. 1;

FIG. 4 is a cut-away perspective view of the locking mechanism of FIG. 1 shown in the unlocked condition in association with a door;

FIG. 5 shows the locking mechanism of FIG. 4 with locking element in the extended position;

FIG. 6 shows the locking mechanism of FIG. 4 in the locked condition; and FIG. 7 is a top view the locking mechanism in the locked condition of FIG. 6.

### DETAILED DESCRIPTION OF THE PREFERRED EMBODIMENT

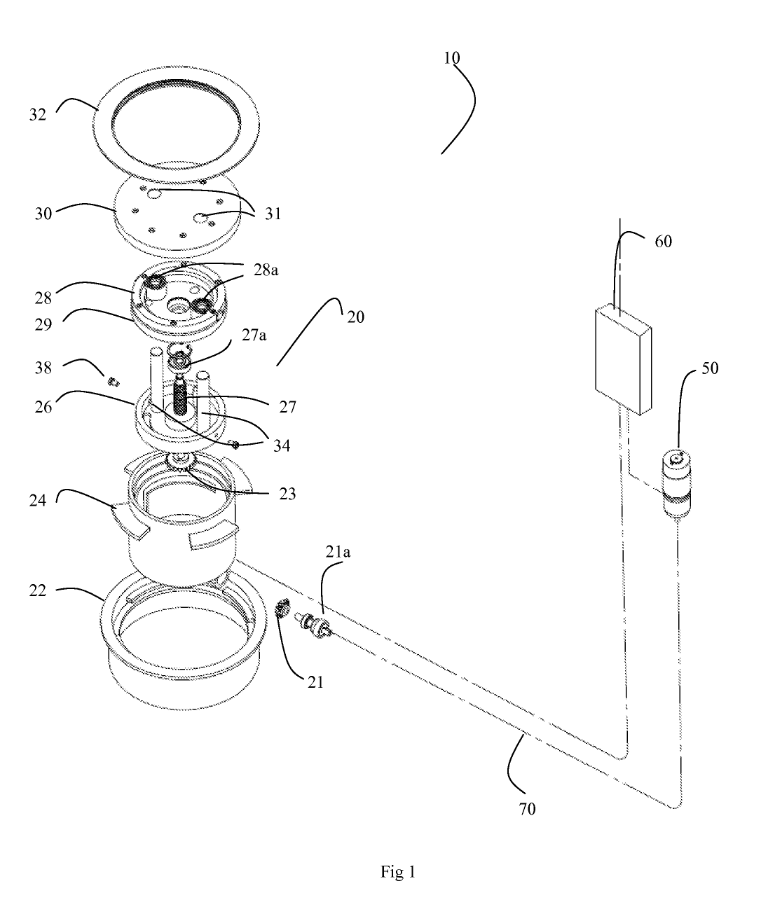

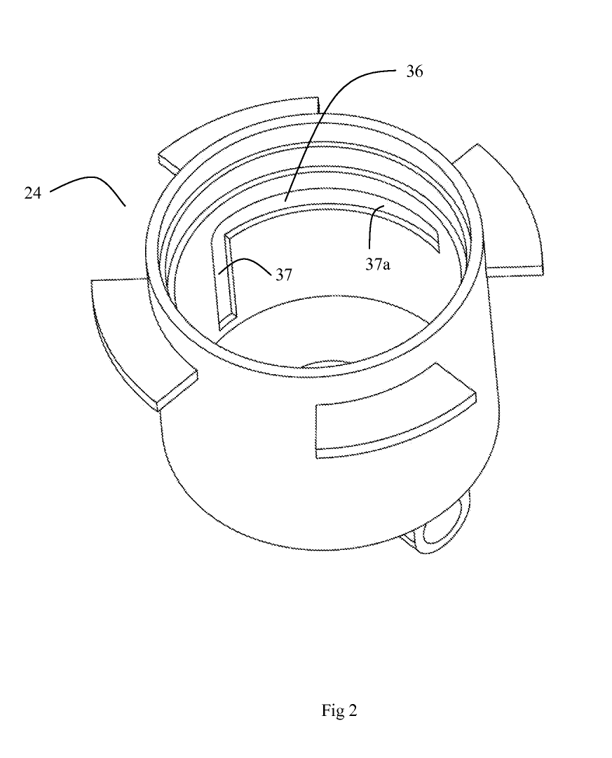

Referring to FIG. 1, a door locking installation 10 is shown including a door locking mechanism 20 shown in exploded view, an electrically powered actuator in the form of electric motor and gearbox combination 50, and a mechanical linkage in the form of flexible drive cable 70. Locking mechanism 20 is arranged to be mounted in the floor below the bottom edge of a door (not shown). A hole is formed in the floor using a core drill of a suitable diameter to seat mounting ring 22 at the top edge of the hole and of sufficient depth to accommodate the mechanism 20. When installed in the floor, the top surfaces of outer cover plate 32 and inner cover plate 30 lie generally flush with the surrounding floor surface.

Flexible drive cable 70 is mounted in a flexible sheath and is arranged to rotate to transfer rotational motion of the output of motor and gearbox combination 50 to the input shaft 21a of mechanism 20. Drive cable 70 operates on the same principle to the type of cable often used as a speedometer cable in automotive applications.

Electric motor 50 is operated under the control of controller 60 which itself is connected to a building control system to allow for remote and automatic operation of the locking installation 10. By causing drive cable 70 to rotate in either a clockwise, or anticlockwise direction, the locking mechanism is caused to move between a locked and an unlocked condition as will be later described.

Importantly, controller 60 and motor and gearbox combination 50 are mounted to a wall to one side of the door and are situated above floor level. Therefore, the electronic components inside controller 60 and motor 50 are not at risk of damage from moisture or liquid that may be present on the floor due to, for instance, rainfall or floor-cleaning operations.

The components and operation of locking mechanism 20 will now be described.

Referring to FIG. 1, locking mechanism 20 includes a housing 24 to which is mounted support plate 28 by way of rotatable roller bearing 29 to allow support plate 28 to rotate with respect to housing 24. A threaded rod 27 is located at its upper end in support plate 28 in smaller roller bearing 27a and is thus rotatable with respect to support plate 28.

A locking element is comprised of a base plate 26 to which are mounted two projecting fingers 34. Base plate 26 is threadedly engaged with threaded rod 27. Therefore, rotation of threaded rod 27 results in either upward or downward movement of base plate 26 with respect to threaded rod 27 depending upon the direction of rotation of threaded rod 27.

Fingers 34 are a sliding fit in bushes 28a of support plate 28 and further sit inside apertures 31 provided in inner cover plate 30. Inner cover plate 30 is affixed to support plate 28 with by way of a series of six equally spaced screws.

Base plate 26 includes two lugs 38 which cooperate with guide means in the form of two diametrically opposed grooves provided on the inner surface of housing 24. Referring to FIG. 2, one of grooves 36 is visible inside housing 24 and includes a vertical portion 37 and a horizontal portion 37a. Grooves control movement of the base plate 27 with respect to housing 24.

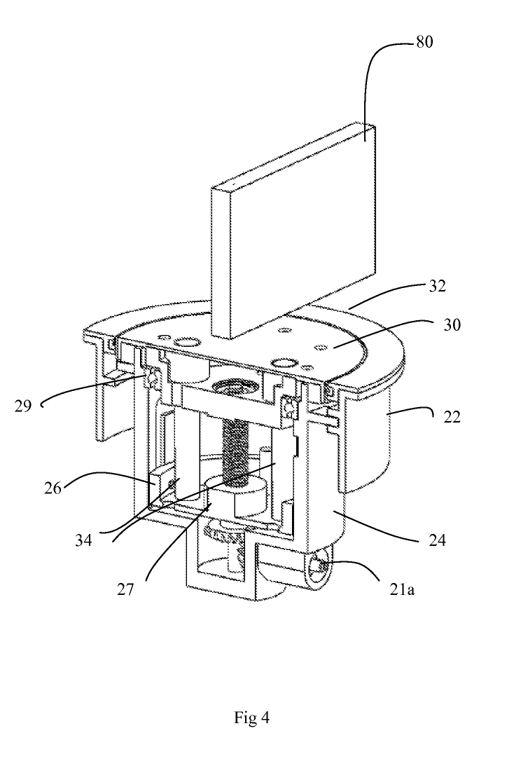

Referring to FIGS. 4, 5 and 6, operation of locking mechanism will be described.

Referring to FIG. 4, mechanism 20 is shown in its unlocked condition. A portion of a door 80 is shown in its usual closed position where it generally overlies locking mechanism 20. Base plate 26 is positioned at the lower end of threaded rod 27 and thus fingers 34 are in their retracted position. The top surfaces of fingers 34 lie flush with inner cover plate 30.

Lock is moved to the locked condition by rotation of input shaft 21 a in an anti-clockwise direction. Rotational movement of input shaft 21 a is translated to rotation of threaded rod 27 by way of bevel gears 21, 23. As threaded rod 27 rotates, it causes upward movement of base plate 26 due to the threaded engagement of the base plate 26 with threaded rod 27. As base plate 26 rises, it is constrained in fixed rotational orientation with respect to housing 24 by virtue of lugs 38 being located in the horizontal portion 37 of grooves 36. As base plate 26 rises, lugs 38 move upwards along groove portions 37 and fingers 34 extend out of the apertures 31 in inner cover plate 30.

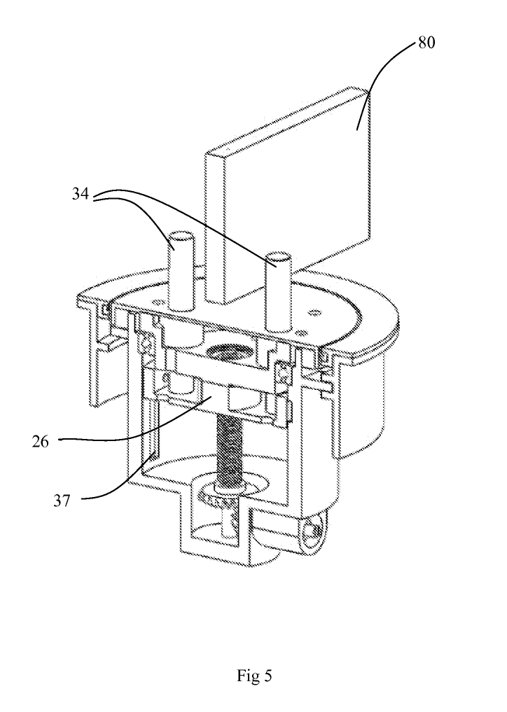

Referring to FIG. 5, fingers 34 are in their fully extended position and lugs 38 have now reached the top of horizontal groove portions 37 and are now free to travel along horizontal groove portions 37a. Furthermore, base plate 26 has reached the limit of upper travel on threaded rod 27 as it has come into contact with support plate 28. Therefore, continued rotation of threaded rod causes rotation of all of support plate 28, base plate 26, fingers 34 and inner cover plate 30 in unison. This brings fingers 34 into contact with opposite sides of door 80 which causes door 80 to become aligned with the centre of rotation of mechanism 20 and to be restrained from movement by way of fingers 34 being in contact with both sides of door 80.

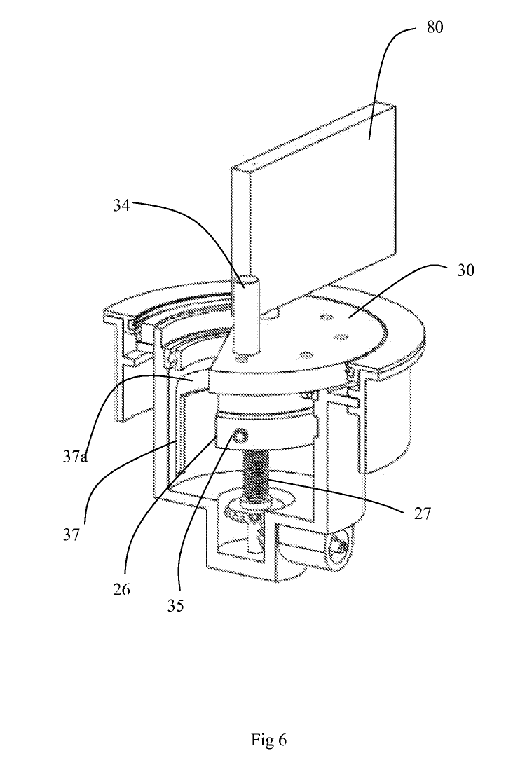

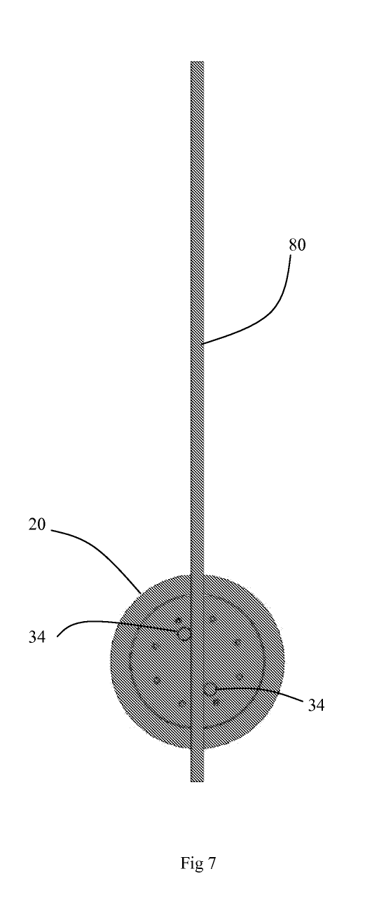

When the mechanism has reached the rotational position shown in FIG. 6, it can move no further. This is detected by controller 60 by a sudden sharp rise in the current drawn by motor 50. When controller 60 detects this condition power to motor 50 is cut. Locking mechanism 20 is now in its locked condition. Door 80 is held locked in place by fingers 34 (see FIG. 7).

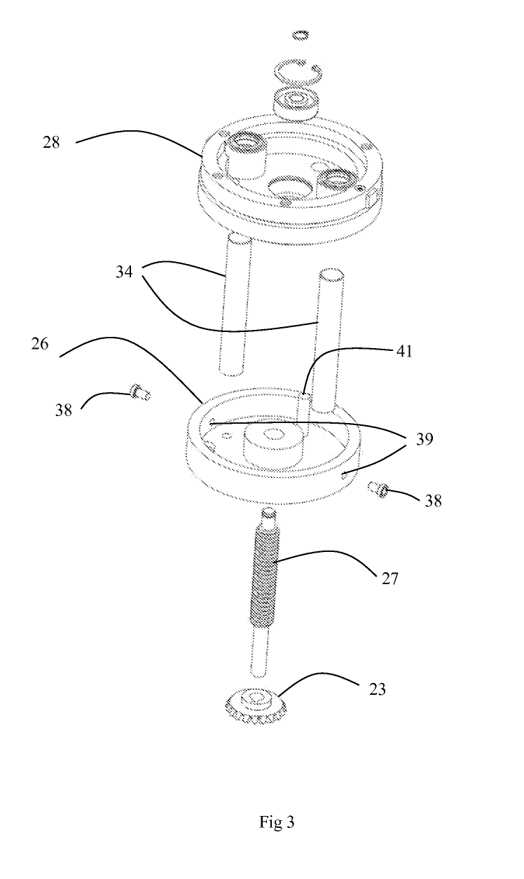

A micro-switch may be operated by post 41 (shown in FIG. 3) to indicate that base plate 26 has reached the upper extent of its travel. Therefore, if controller 60 detects a rise in current and micro-switch has not been operated then this indicates that lock 20 has not successfully moved to the locked condition. Controller can then back up the motor and attempt to repeat the locking operation, and may indicate an error condition after a number of failed attempts.

Movement from the locked condition back to the unlocked condition shown in FIG. 4 is achieved by rotation of input shaft 21 a in the opposite direction. Initially, rotation of threaded rod causes rotation of the assembly of support plate 28, base plate 26, fingers 34 and inner cover plate 30 with respect to housing 24 back to the position shown in FIG. 5 as lugs 38 move along groove portions 37. Thereafter, lugs 38 prevent continued rotation, and base plate 26 moves back down threaded rod 27 until the position shown in FIG. 4 is reached. When base plate 26 can move no further, this causes a sharp rise in the current drawn by motor 50 signalling to controller that the mechanism has reached the unlocked condition. Power to motor 50 is then cut and mechanism remains in the condition shown in FIG. 4. With fingers 34 again retracted, door 80 can be freely opened.

A microswitch may be employed to detect that the lugs 38 have rotated to align with vertical groove portions 37 before the sharp rise in motor current is detected to allow controller 60 to determine whether the mechanism has properly moved to the unlocked condition. In the event that the motor current rises before the lugs 38 have aligned with groove portions 37 the controller backs up the motor and tries a number of times to unlock the lock. Repeated failure will cause indication of an error condition.

The controller 60 includes a power storage device such as a battery or super-capacitor to enable fail safe operation. When operating in fail safe mode, in the event that power is cut to controller and the locking mechanism is in the locked condition, the controller uses power stored in the power storage device to move the locking mechanism to the unlocked condition.

It can be seen that embodiments of the invention have at least one of the following advantages:
The locking mechanism mounted below floor level does not include any electrical driving parts such as an electric motor. Therefore, these parts are not susceptible to damage by way of ingress of water or other liquids which may be present on the floor.
The locking fingers of the mechanism are positively driven from the retracted position to the extended position and from the extended position back to the retracted position to provide reliable operation of the lock.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A door locking installation comprising:
a locking mechanism mounted below floor level in association with a door and including a locking element which is moveable between a retracted position and an extended position;
an electrically powered actuator which is arranged to drive the locking mechanism by way of a mechanical linkage;
the mechanical linkage separates the actuator from the locking mechanism; and
wherein the actuator is mounted above floor level.

2. A door locking installation according to claim 1 wherein the mechanical linkage includes a flexible drive cable mounted in a flexible sheath.

3. A door locking installation according to claim 2 wherein the flexible drive cable is arranged to rotate within the flexible sheath.

4. A door locking installation according to claim 1 further including a power storage device to provide power to the lock in the event that mains power is lost.

5. A door locking installation according to claim 4 which is arranged to move the lock to an unlocked condition in the event that mains power is lost.

6. A locking mechanism which is arranged for mounting below floor level in association with a door including:
a housing;
a locking element is mounted in the housing and is associated with a threaded element;
rotation of the threaded element causes movement of the locking element between a retracted position and an extended position.

7. A locking mechanism according to claim 6 wherein the locking element includes two projecting fingers.

8. A locking mechanism according to claim 6 wherein, when in the extended position, the locking element is arranged to rotate between a first position and a second position.

9. A locking mechanism according to claim 8 wherein the housing includes guide means which controls rotational movement of the locking element.

10. A locking mechanism according to claim 9 wherein the guide means includes grooves provided on the inside surface of the housing.
